(19) United States
(12) Patent Application Publication
(10) Pub. No.: US 2019/0122447 A1
(43) Pub. Date: Apr. 25, 2019

(54) METHODS AND SYSTEMS FOR PAYMENTS OF SERVICES USED BY VEHICLES BASED ON TIME, DISTANCE AND PLACE

(71) Applicant: Asad Ullah SHAH, Hercules, CA (US)

(72) Inventor: Asad Ullah SHAH, Hercules, CA (US)

(21) Appl. No.: 15/792,606

(22) Filed: Oct. 24, 2017

(51) Int. Cl. G07B 15/02; G07B 15/06; H04W 4/04; H04W 4/02; G06Q 20/14; G06Q 20/10; G06Q 20/08

(52) U.S. Cl. CPC G07B 15/02; G07B 15/06; H04W 4/046; G06Q 20/085; G06Q 20/145; G06Q 20/10; H04W 4/021

(57) ABSTRACT

A computer-implemented method includes receiving, by a server system, geo-location information corresponding to a vehicle at predefined time intervals. The geo-location information is received from an in-vehicle device (IVD) present in the vehicle. The server system determines if the vehicle is utilizing a service at a service location based on the geo-location information. If usage of the service is determined, the server system calculates a fee associated with the usage of the service by the vehicle at the service location based on TDP, time distance, place. The server system thereafter facilitates a payment of the fee based on a payment authorization information received from the IVD, where the payment is made from at least one payment account linked with the vehicle.

### TECHNICAL FIELD

Embodiments of the disclosure relate generally to Internet of Things (IOT) and, more particularly, to making payment transactions for usage of services such as toll road, parking and the like, using location information of vehicles.

### BACKGROUND

While taking a vehicle out on the roads, several issues related to finding a parking spot, paying for the exact parking time, waiting in a queue at a toll booth, and making payments, etc., cause frustration to a vehicle operator. For instance, while finding a parking spot, the vehicle operator may have anxiety concerning getting a parking ticket, figuring out the diverse types of parking meters and burning fuel while trying to find a parking spot, among others. Moreover, on the flip side, huge upfront cost of parking meters and inability to adjust pricing based on demand or events, are some of the issues faced by municipalities, parking operators, traffic and transport related agencies.

In addition, enforcement agencies also face challenges while dealing with issues related to parking tickets, toll road usage, etc. For instance, a person associated with an enforcement agency must go car by car to check for parking infractions/violations. In some areas, there may be a scarcity of parking spaces, while many small areas that could be used for parking are not used because it is not economical to put up meters. On the other hand, for private parking lot, collecting fees for the parking lot owners, is also a complex task. Book keeping, pilferage, salaries of attendants, purchase and maintenance costs of ticket vending machines, installation of gates, kiosks, etc., add to the difficulties.

Techniques for charging for toll roads, is well established all over the world. For example, manned or automated toll booths at exits and entrances to highways, bridges, etc., are common. However, collection of toll charges at a toll booth leads to lengthy queues of vehicles approaching the booth, which results in loss of time for the vehicle operators. In many cities, there are provisions for prepaid passes having RFID tags, etc. The manned or the automated toll booths may deploy a card reader to read the tag and allow the vehicles to pass through dedicated lanes for the prepaid pass holders, without having need to pay at the toll booths. However, these systems require a lot of physical infrastructure, cost and labor for enforcement, thereby making it inefficient both from operational and economical stand point. In addition to the high cost of construction and operating costs, these systems are not flexible as they rely on physical infrastructure (booths, parking meters, cameras, etc.), and therefore are unable to address the changing needs.

### SUMMARY

Various embodiments of the present disclosure provide systems and methods for distributing on-demand items to a recipient.

An embodiment provides a method for making payment by a vehicle for usage of a service such as toll road, parking facility etc. The method includes receiving, by a server system, geo-location information corresponding to a vehicle at predefined time intervals, where the geo-location information is received from an in-vehicle device (IVD) present in the vehicle. The method further includes determining, by the server system, if the vehicle is utilizing a service at a service location based on the geo-location information of the vehicle received at predefined time intervals. If the vehicle is determined to be utilizing the service at the service location, the server system calculates a fee associated with a use of the service by the vehicle at the service location. Thereafter, the method includes facilitating, by the server system, a payment of the fee based on a payment authorization information received from the IVD, where the payment is made from at least one payment account linked with the vehicle.

Another embodiment provides a server system including a communication interface for receiving geo-location information corresponding to a vehicle at predefined time intervals. The geo-location information received from an in-vehicle device (IVD) present in the vehicle. The server system includes a processor, which upon receipt of the geo-location information, is configured to cause the server system to at least determine if the vehicle is utilizing a service at a service location based on the geo-location information of the vehicle received at predefined time intervals. The server system is further caused to calculate a fee associated with a use of the service by the vehicle at the service location if the vehicle is determined to be utilizing the service at the service location. The server system is further caused to facilitate a payment of the fee based on a payment authentication received from the IVD, where the payment made from at least one payment account linked with the vehicle.

Another embodiment provides a method making payment by a vehicle for usage of a service such as toll road, parking facility etc. The method includes collecting geo-location information corresponding to the vehicle, by an in-vehicle device (IVD) present in the vehicle. The method includes transmitting the geo-location information to a server system at predefined time intervals. If the vehicle is utilizing a service at a service location, the method includes receiving a fee associated with usage of the service from the server system. The server system determines whether the vehicle is utilizing the service if a geo-location of the vehicle determined from the geo-location information corresponds to the service location. The method thereafter includes providing a payment authorization information to the server system to make a payment of the fee from at least one payment account linked with the vehicle.

### BRIEF DESCRIPTION OF THE FIGURES

For a more complete understanding of example embodiments of the present technology, reference is now made to the following descriptions taken in connection with the accompanying drawings in which:

FIG. 1 illustrates a schematic representation of an environment including a server system, a vehicle, among other systems, related to at least some embodiments;

FIG. 2A illustrates a schematic representation of positioning of an IVD in a vehicle, in accordance with an embodiment;

FIG. 2B illustrates a simplified block diagram of a composite system comprising the IVD and auxiliary location input devices, in accordance with an example embodiment;

FIG. 2C is a schematic representation of a circuit diagram of the IVD and its components, in accordance with an example embodiment;

FIG. 2D is a simplified schematic illustration of the auxiliary location input devices of the vehicle, in accordance with an example embodiment;

FIG. 3 is a simplified block diagram representation of the server system, in accordance with an example embodiment;

FIG. 4 is a simplified representation of registration of a vehicle and services offered by service provider entities, in accordance with some example embodiments;

FIGS. 5A and 5B are simplified illustrations of parking lot environments for parking of a vehicle, in accordance with at least some embodiments;

FIG. 6A illustrates an example representation of a use case associated with a toll road usage, in accordance with an embodiment;

FIG. 6B illustrates an example representation of a use case associated with usage of a high occupancy vehicle (HOV) lane, in accordance with an embodiment;

FIG. 6C is an example schematic representation of an interface of the digital platform, where the interface displays a digital map of a toll road, in accordance with an embodiment;

FIG. 7 is a simplified illustration of an interface displaying a navigated route in an urban setup, in accordance with an embodiment;

FIG. 8 is a simplified flowchart illustrating a method for facilitating payment transaction for using a service based on a vehicle's geo-location information, in accordance with at least some embodiments; and

FIG. 9 is a simplified block diagram of the server system, in accordance with one embodiment.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide methods and systems for facilitating payment transaction, for using services on road or parking lot, using a geo-location of a vehicle.

Embodiments provide a server system in operative communication with vehicles, where the vehicles include an in-vehicle device (IVD). The IVD is configured to determine real-time geo-location information of the vehicle, and provide the information to the server system at pre-defined intervals (or on real-time basis). The IVD may be connected to an on-board diagnostics (OBD) port provided in the vehicle, or can be installed standalone, and it includes a processor, a geo-location signal receiver such as a GPS receiver, and a cellular communication module such as a Subscriber Identity Module (SIM). Using the satellite signals received by the GPS receiver, the IVD is configured to provide the geo-location information to the server system. The IVD also receive supplemental location inputs from devices such as a camera, one or more modules for light and sound navigation such as, RADAR and LIDAR modules, a machine readable code reader, mounted at an exterior of the vehicle, such as the roof, the rear view mirrors or the hood of the vehicle. The IVD is configured to filter out noise components from the geo-location signals (i.e. the satellite signals) to accurately determine the geo-location information of the vehicle, prior to transmitting the geo-location of the vehicle to the server system, wherein the noise components may be a result of the satellite signals subjected to multipath effect in urban canyons. The transmission of the geo-location of the vehicle to the server system by the IVD is enabled by a communication network facilitated by the SIM.

The server system uses the geo-location information of the vehicle to determine whether the vehicle is utilizing a service at a service location. Some examples of the services may include, but are not limited to, a vehicle parking service, a toll road usage (electronic pricing of roads), a high occupancy vehicle (HOV) lane usage or congestion based pricing of roads. Examples of the service locations include, but are not limited to, parking lot, toll roads and HOV lanes. The server system uses the geo-location information along with the supplemental information received from the camera, RADAR and LIDAR modules, machine readable code readers, to accurately determine whether the vehicle is utilizing the service at the service location or not. Once, the server system determines that the vehicle is using the service at a particular service location, the server system calculates a fee for usage of such service. The server system stores (or otherwise accesses from external databases) information corresponding to one or more of fee schedules, tariff rates associated with parking duration and use of toll roads and distance travelled, parking policies, toll road use policies and policy change rules that effect prices, to calculate the fee. The server system also uses the information such as a parking duration of the vehicle at a parking slot, a distance travelled on a toll road or an HOV lane to calculate the fee. Some more information such as TDC or time distance and place of service location can also be used for calculation of the fee. The server system generates a bill for the service utilized by the vehicle, and the bill is displayed at a display interface linked with the IVD present in the vehicle. The bill amount may be deducted upon receiving an authorization from an operator of the vehicle or may be deducted autonomously from a payment account associated with the operator of the vehicle for making payment to a payment account linked with the service provider. In some scenarios, the IVD can detect the location and place of service, and as such, the driver can just walk out of the car in case of parking or keep driving in case of toll, and the billing can be automatically performed using the payment account linked with the vehicle.

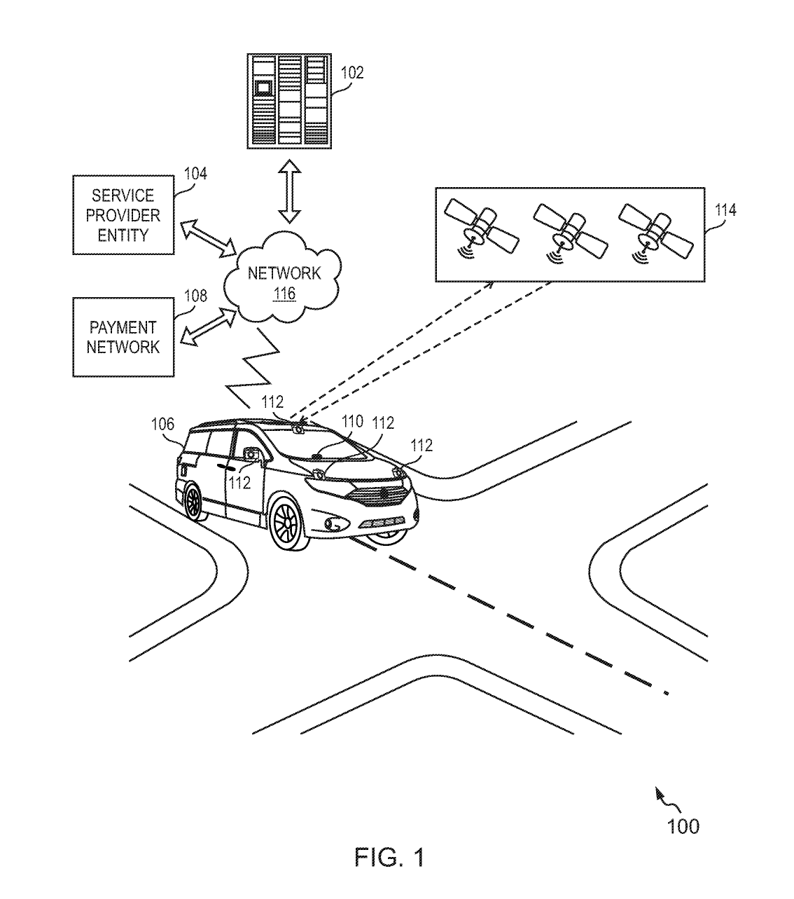

FIG. 1 is a simplified illustration of an environment 100 in which a server system 102, a service provider entity 104 and a vehicle 106 are shown. The vehicle 106 may use various services while on road such as a toll road, HOV lane, or a parking facility. The vehicle 106 and/or an occupant/operator of the vehicle 106 are registered with the server system 102. Similarly, the service provider entity 104 is also registered with the server system 102. Examples of the service provider entity 104 includes various government or non-government agencies that may be responsible for managing construction, upkeep or maintenance of the service locations to be used by the vehicle 106. For instance, some non-exhaustive example of the service provider entity 104 may be a toll plaza company, an agency managing a parking lot, freeway maintenance authority, road and transport department of government, municipalities, etc.

The vehicle 106 is equipped with a composite system for providing the geo-location information of the vehicle 106 to the server system 102. The geo-location information is used by the server system 102 to determine whether the vehicle 106 is using any service at any of the service locations. Such determination can be done at a real-time basis, and accordingly the geo-location information of the vehicle 106 can be received on a continuous basis. Once, it is determined at the server system 102 that the vehicle 106 is using the service at a particular service location associated with the service provider entity 104, the server system 102 calculates appropriate fee for the usage of such service. The server system 102 further facilitates a payment of the calculated fee from at least one vehicle payment accounts to at least one service provider payment account. The server system 102 uses services of a payment network 108 (e.g., MasterCard®, VISA®, American Express®, PayPal®, etc.) for realizing the payment between the vehicle payment account and the service provider payment account. Herein, a vehicle payment account refers to a payment account associated with either an owner of the vehicle 106, an operator of the vehicle 106, or even any occupant of the vehicle 106. However, there may be default payment account linked with the vehicle 106, as set by the owner of the vehicle 106. Further, the service provider payment account is a receiver payment account (associated with the service provider entity 104) that is used for receiving the payment from the vehicle payment account.

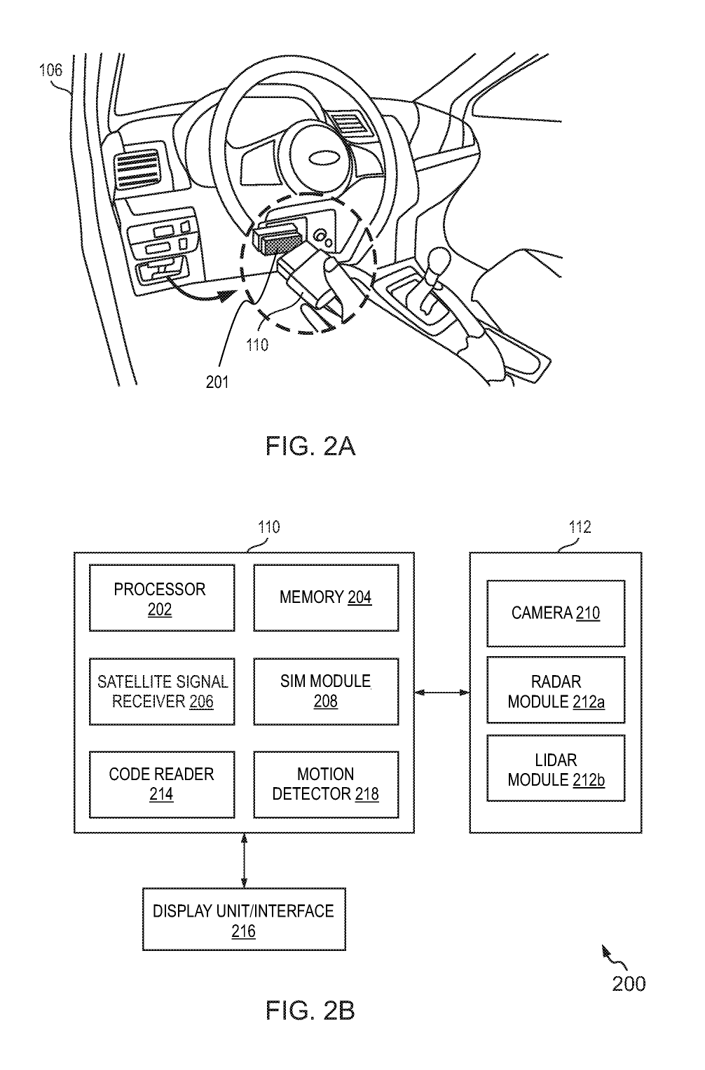

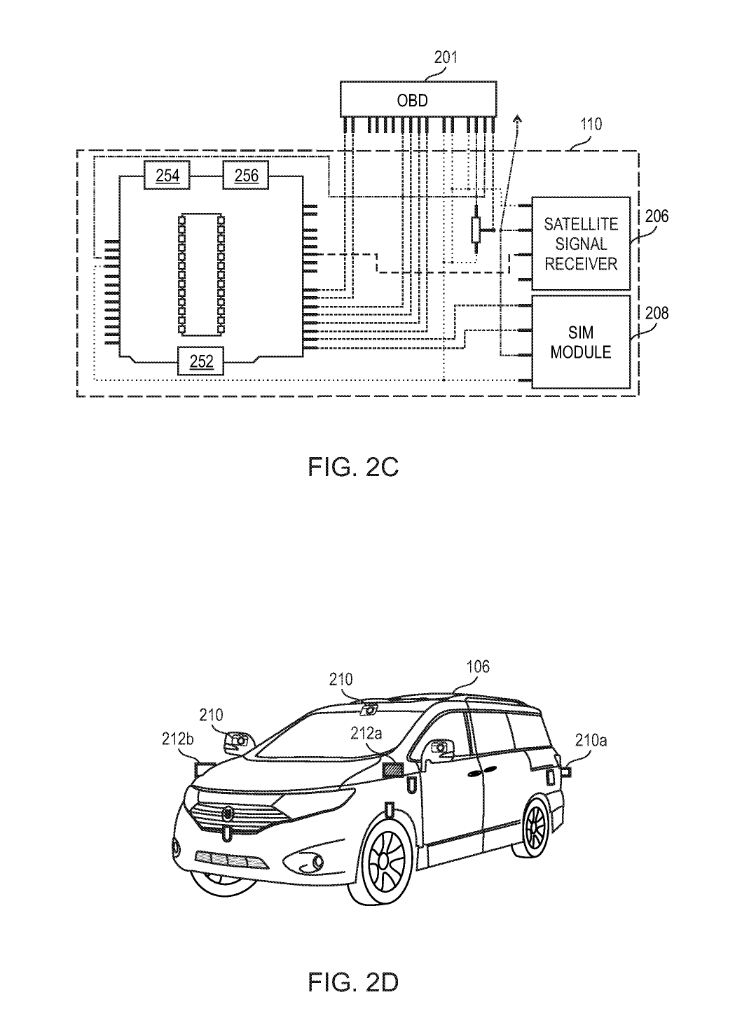

The composite system can be deployed within and/or upon the vehicle 106. The composite system includes an in-vehicle device (IVD) 110 and one or more auxiliary location input devices 112. In an embodiment, the IVD 110 may be a single computing module comprising one or more components integrated within the module. The IVD 110 may be appropriately deployed inside the vehicle, as described later with reference to FIGS. 2A-2D. In some alternate embodiments, the IVD 110 may also be configured in form of multiple sub-systems disposed at different locations within the vehicle 106 and each component may be connected by means of cables, wires or through wireless connection.

The auxiliary location input devices 112 can be appropriately disposed within the vehicle 106 or upon exterior such as the roof, back of the rear view mirrors, bonnet (hood) of the vehicle 106, among others. Examples of the location input devices 112 includes, but are not limited to, a camera, one or more modules for light and sound based navigation such as RADAR and LIDAR modules, and a machine readable code reader (e.g., QR code reader). The IVD 110 is also associated with a vehicle display unit/display interface typically placed over the dashboard of the vehicle 106. The display is visible to the operator/driver of the vehicle 106. The IVD 110 is communicably linked to the location input devices 112, and include interfaces for connecting with the location input devices 112 so as to receive location related inputs from the location input devices 112.

The IVD 110 includes a geo-location signal receiver or tracker (e.g., a satellite signal receiver). An example of the geo-location signal receiver of the IVD 110 may be a GPS receiver. The satellite signal receiver for example, the GPS receiver of the IVD 110 (shown in FIG. 2) may receive signals from a satellite system 114. An exemplary representation of three satellites of the satellite system 114 are shown in FIG. Examples of the satellite system 114 may include GPS, GNSS, Galileo, GLONASS, LORAN, BeiDOU, NAVIC, QZSS and the like. The satellite signal receiver calculates the vehicle's geo-location based on signals exchanged from the satellite system 114. Alternatively, or additionally, a SIM module (e.g., based on GSM mobile communication) of the IVD 110 may receive signals from cellular base station antennas and calculate the receiver's geo-location based on changing stations.

The geo-location of the vehicle may be transmitted to the server system 102 at a predefined time intervals. The server system 102 may store (or otherwise has access to) location information (e.g., latitude, longitude, etc.) of places within a specific area or of the whole globe. For instance, the server system 102 may include a digital map of a given geographical area (such as a city, state or a country) or of the entire world. Alternatively, the server system 102 may communicate with one or more servers, such as, servers associated with Google® Map to receive location information. A plurality of places/locations may be pinned or marked as service locations on the digital map by the server system 102. The service locations may include a parking lot and a toll road and high occupancy vehicle (HOV) lanes, among others. The service providers associated with the service locations that are pinned or marked on the digital map, may be registered with the server system 102.

The server system 102 and the IVD 110 are capable of communicating with one another through a communication network 116. The IVD 110 may have sub-systems for using the communication network 116. Examples of the communication network 116 are any type of wireless communication network. Accordingly, the IVD 110 is equipped with a wireless module such as a Subscriber Identity Module (SIM) (shown in FIG. 2). In an embodiment, the SIM module may also facilitate receiving signals from the base station antennas thereby enabling tracking a location of the vehicle 106.

The server system 102 determines if the geo-location of the vehicle 106 corresponds to a service location. Based on the determination, the server system 102 understands if the vehicle 106 is utilizing a service on one or more of the service locations. Alternatively or additionally, the server system 102 may receive information as to whether the vehicle 106 is utilizing a service at a service location, wherein the service is provided by the service provider entity 104. The server system 102 calculates a fee associated with the service utilized by the vehicle and facilitates a payment transaction upon calculating the fee associated with the service utilized.

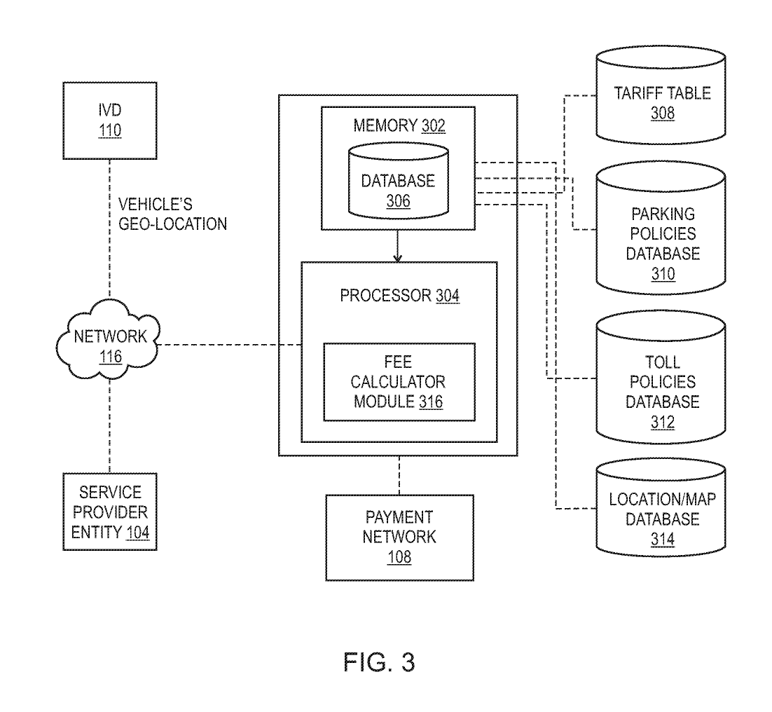

In an embodiment, the server system 102 may be a remote virtual server such as a cloud server. The server system 102 may be an applications server hosted by a third party entity. The server system 102 includes a database (shown in FIG. 3) that stores information corresponding to one or more of fee schedules, tariff rates, parking policies, toll use policies, any changes in policy or rules that may affect prices, and digital maps corresponding to various states/geographies and applications laws.

The IVD 110 and the auxiliary location input devices 112 are herein described with reference to FIGS. 2A-2D.

Referring to FIG. 2A, positioning of the IVD 110 in a vehicle such as the vehicle 106 is shown, in accordance with an example embodiment. As shown in FIG. 2A, the IVD 110 is connected to a port of on board diagnostics (OBD) 201 of the vehicle. The OBD 201 is generally configured under the dashboard of the vehicle, however, it can be configured at other suitable places in the vehicle as well. The OBD 201 can be a computing device with connectors/interfaces to provide information about status of the multiple electronics subsystems of the vehicle to a technician. The OBD 201 generally derives power from the vehicle itself and does not need external batteries. It should be noted that the IVD 110 can also be configured at other locations within the vehicle such as in the trunk.

Referring to FIG. 2B, a simplified block diagram of a composite system 200 comprising the IVD 110 and the location input devices 112 is shown, in accordance with an example embodiment. The IVD 110 is communicably connected to the location input devices 112 for receiving location specific data, so as to process the data to obtain the geo-location information and information of surroundings of the vehicle.

In an example embodiment, the IVD 110 includes a processor 202, a memory 204, a satellite signal receiver 206 (hereinafter also referred to as a GPS receiver) and a SIM module 208. In an example embodiment, the location input devices 112 include, but not limited to, a camera 210, a light and/or sound navigation system including a RADAR module 212a and a LIDAR module 212b. The composite system 200 further includes a machine readable code reader 214 such as a QR code reader that can be integrated as part of the IVD 110. The IVD 110 is also coupled to a display unit 216 and to a motion detector 218. In an example embodiment, the motion detector 218 may include sensors such as gyroscope, accelerometer, etc., and can be entirely embodied in the IVD 110.

In an embodiment, the components of the location input devices 112 may be disposed at the exterior of the vehicle. As an example, the camera 210, the RADAR module 212a and the LIDAR module 212b may be mounted on at least one of the roof, the bonnet or the back of the rear view mirrors of the vehicle as seen in FIG. 2D. The display unit 216 is provided at the dashboard of the vehicle so as to be in line of sight of the operator/driver of the vehicle.

As discussed earlier, the GPS receiver 206 receives location signals from the satellite system 114 and determines the geo-location of the vehicle 106. The SIM module 208 facilitates the IVD 110 to use the communication network 116 to communicate with the server system 102. The communication network 116 includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, network link may further include, or alternately include, a variety of communication channels and networks such as WLAN/Wi-Fi, WiMAX, Wide Area Networks (WANs), and Bluetooth.

The machine readable code reader 214 can be a part of the IVD 110, and it may include sensors/scanners capable of reading/scanning optical characters, barcodes and QR codes, among others. Examples of the machine readable code reader 214 may include barcode scanners, QR code scanners and optical character recognition devices, among others. In an example embodiment, the machine readable code reader 214 takes the image/video inputs from the camera 210, and process the image/video input to read/scan the optical characters, barcodes, QR codes, etc.

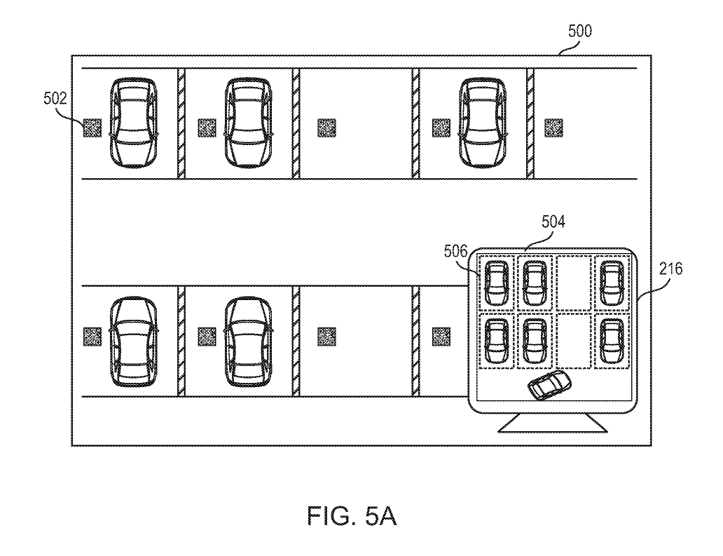

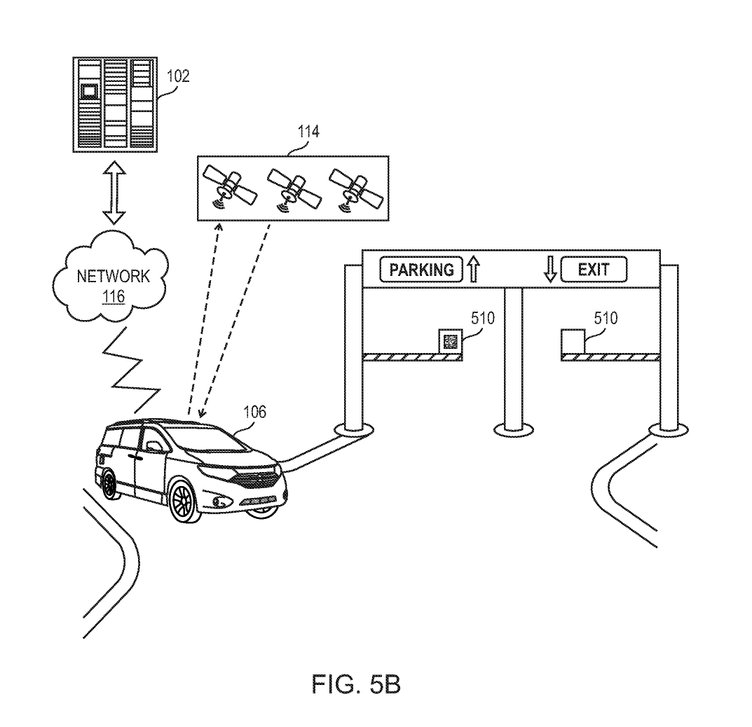

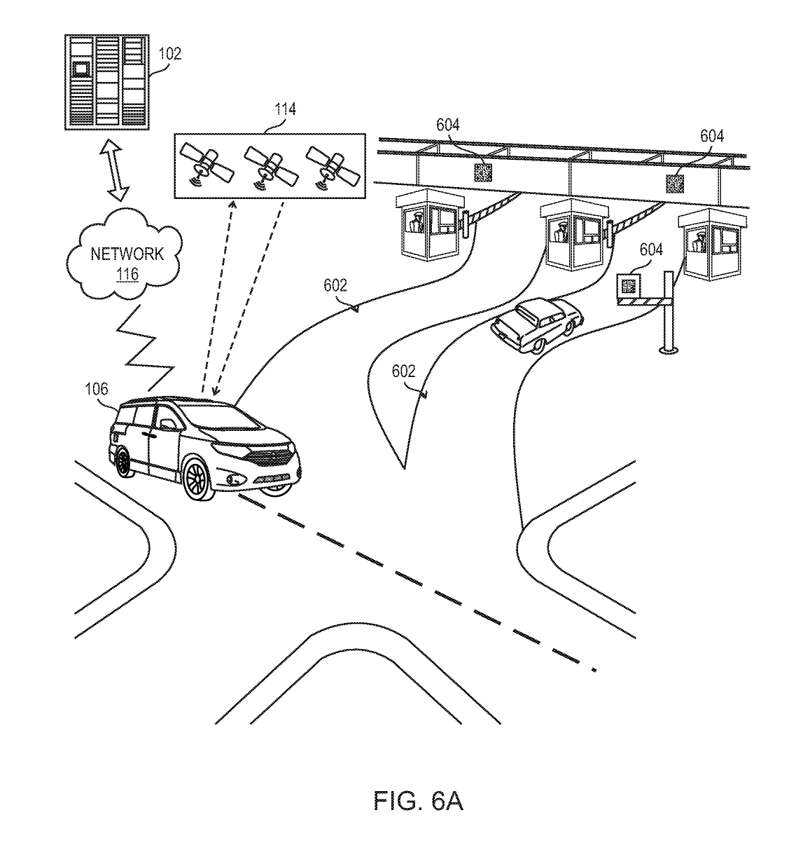

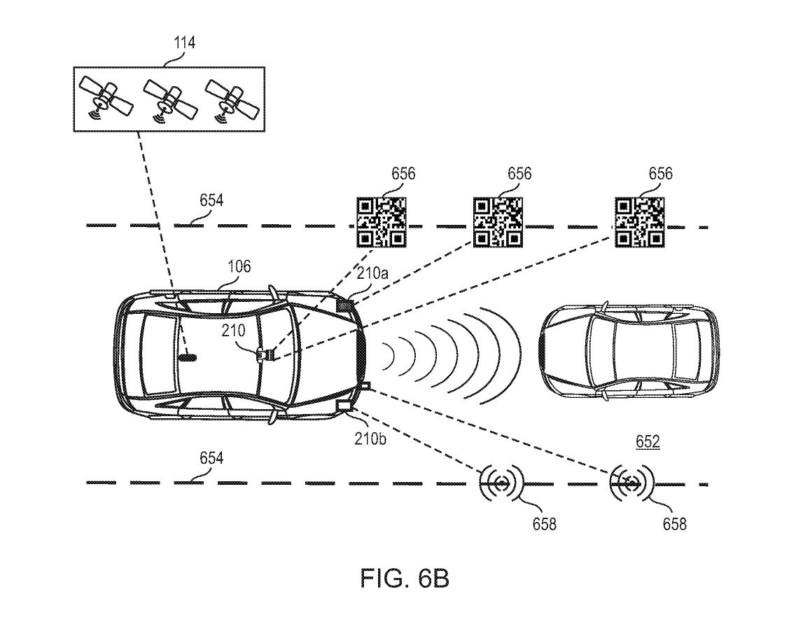

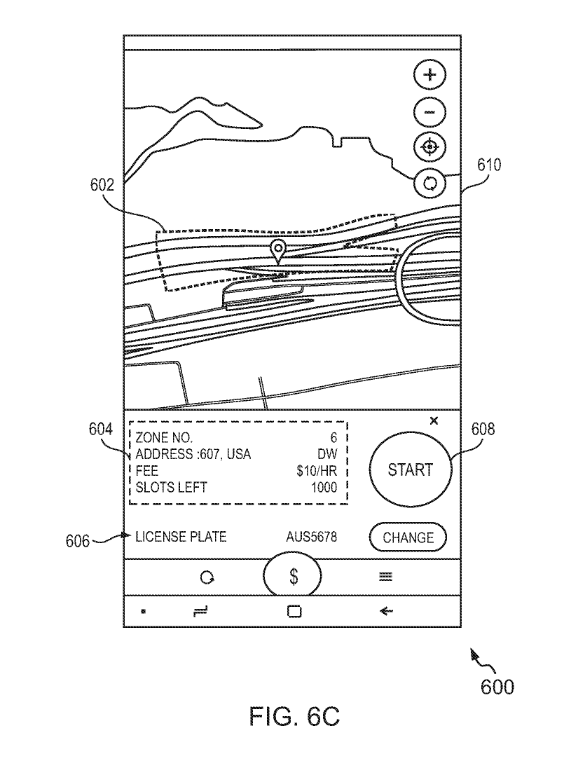

The machine readable code reader 214 may be used to scan machine readable codes provided at an entry of a parking lot, parking slots within the parking lot, an exit of the parking lot (shown in FIGS. 5A, 5B), at an entry of a toll gate, and at an exit of the toll gate (shown in FIG. 6A). Scanning the machine readable codes at the entry and the exit of a parking lot may track the geo-location of the vehicle, and provides confirmation of the presence of the vehicle at the service location. Further, a time of arrival and a time of departure may be logged in the server system 102, and accordingly the duration of parking is determined. Likewise, the machine readable codes at the entry of the toll gate and at the exit of the toll gate may track a vehicle presence at an entry lane and at an exit lane, respectively, and then a distance travelled by the vehicle from the entry toll gate to the exit toll gate is determined.

The display unit/interface 216 may be provided on the dashboard of the vehicle facing the operator (e.g., driver) of the vehicle. The display interface 216 may enable the operator to provide data (payment authorization information) corresponding to authorization of the operator for the payment transactions. The fee for utilizing a service by the vehicle and the bill indicating the fee may be displayed at the display interface 216. The display interface 216 is also used to display a digital map, the current geo-location of the vehicle and a route navigation to a destination to which the vehicle is travelling.

The motion detector 218 is configured to determine whether the vehicle is in motion or is at rest. For example, upon determining the geo-location of the vehicle and determining that the geo-location corresponds to a service location (e.g., a parking lot), if the motion detector 218 suggests that the vehicle is at rest for a pre-determined time period, the server system 102 may determine that the vehicle is parked at a parking slot within the parking lot. Subsequently, the server system 102 may log the time, at which the vehicle had come to rest and when the vehicle had started movement from the parking lot, in order to determine the parking duration.

FIG. 2C is a representation of a circuit diagram of the IVD 110 showing its components and a connection of the IVD 110 to a port of the OBD 201. The IVD 110 is connected to OBD 201 using connectors. The IVD 110 includes an integrated circuit (e.g., a semiconductor chip) of the GPS receiver 206, an integrated circuit (e.g., a semiconductor chip) of the SIM module 208, an interface 252 for the camera 210, an interface 254 for the RADAR module 202a, and an interface 256 for the LIDAR module 202b.

An exemplary representation of the location input devices 112 of the vehicle 106 are shown in FIG. 2D. As illustrated, the camera 210 may be disposed at the exterior of the vehicle 106 such that the camera 210 captures images of the surroundings of the vehicle 106. In the illustrated representation, more than one cameras (e.g., the camera 210) are shown as mounted at the exterior of the vehicle 106. The geo-location information of the vehicle 106 may be determined (e.g., augmented upon location determination obtained on the basis of the GPS receiver 206) based on the surroundings of the vehicle 106 captured by the camera 210. For instance, the geo-location information obtained from the GPS receiver 206 may be combined with the images/videos received from the camera 210 to accurately determine the geo-location information, and to verify whether the vehicle 106 is utilizing any service (e.g., a HOV lane or a parking lot) or not. In some embodiments, there may be a single camera 210 that is configured to rotate 360 degrees and capture images of the surroundings of the vehicle 106 (e.g., a 360-degree view camera), which can be streamed in near real time to the IVD 110.

As illustrated in FIG. 2D, the RADAR module 212a and the LIDAR module 212b are also mounted on the exterior of the vehicle 106. The modules 212a,21b are used for object detection using sound and light based detection techniques, and ranging techniques. For instance, the RADAR module 212a and the LIDAR module 212b detect a geo-location of the vehicle 106 and the distance travelled by the vehicle 106 based on calculation of distance and velocity of reflected light and sound waves when the waves encounter any obstruction in the path of the vehicle 106.

Referring now to FIG. 3, a simplified block diagram of the server system 102 is illustrated. The server system 102 includes a memory 302 and a processor 304. In an embodiment, the memory 302 includes a database 306, which may store details of vehicles (e.g., 106), details of service provider entities (e.g., 104), information corresponding to one or more of parking policies, toll use policies, tariff tables, policy changes. The database 306 may further store a digital map or location information of localities. In another embodiment, the processor 304 may receive the information corresponding to one or more of parking policies, toll road use policies, tariff tables and policy changes from a plurality of external databases such as a tariff table 308, a parking policies database 310 and a toll policies database 312, respectively. The processor 304 may receive location information or communicate with a database 314 storing a digital map or location information as described earlier. The processor 304 may communicate with the plurality of external databases 308, 310 and 312 and 314 by means of a communication network similar to communication network 116.

The database 306 may further store information corresponding to a plurality of operators of vehicles including the vehicle 106. The database 306 may further store information corresponding to service providing entities associated with services such as ‘vehicle parking’ and ‘toll road usage’.

The processor 304 is configured to execute a series of computer executable codes in order to process data received from the IVD 110 and the memory 302 in order to determine parking duration of the vehicle at a parking lot or a distance travelled by the vehicle on a road where toll charges apply, and eventually calculate associated fees. In an embodiment, the processor 304 includes a fee calculator module 316. The fee calculator module 316 takes, as input, the parking duration and/or the distance travelled based on changes in the geo-location of the vehicle and service location. Further, the fee calculator module 316 takes as input the information on toll policies, parking policies and tariffs, and calculates a fee associated to parking and/or distance travelled. Subsequently, a bill is generated indicating the fee calculated by the fee calculator module 316.

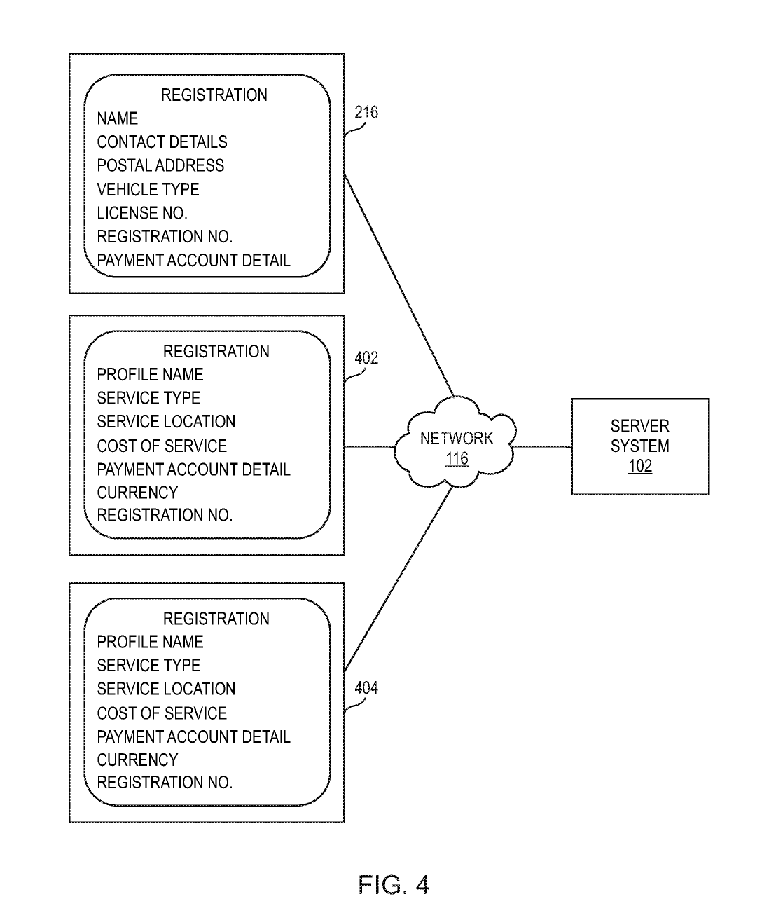

In another example embodiment, the processor 304 is configured to generate one or more bills indicating the fees of all the services, respectively, utilized over a predefined period, at the end of the predefined period. The predefined period, as an example, may be 1 month. In another example embodiment, the processor 304 is configured to generate a single bill indicating the total fees of all the services utilized over a predefined period, at the end of the predefined period. In some scenarios, a pre-paid bill may also be generated, and fee calculated corresponding to actual usage of the services can be set off against the pre-paid bill. For instance, based on an anticipated usage pattern of a particular vehicle, the server system 102 may require the vehicle owner to make a prepayment of say 100$, which can be deducted based on actual usage of the services by the vehicle. For using the pre-paid or post-paid billing, users of the vehicles and the services providing entities will be registered with the server system 102, as discussed in FIG. 4.

FIG. 4 is a simplified illustration of the server system 102 facilitating registration of the vehicle by an owner/operator/driver of the vehicle and registration of the service offered by a service provider entity at the service location, in accordance with some example embodiments. Registration of the vehicle by the vehicle owner may be facilitated at the display interface 216 of the IVD 110. The server system 102 provides a digital platform (i.e. a road/parking service application), wherein the digital platform provisions UIs enabling interaction of the vehicle owner with the server system 102. For instance, one or more UI screens, generated by the digital platform, can be displayed on the display interface 216, and such UIs can include options to provide inputs in form of text field, drop down menu, etc. Accordingly, the owner or an operator of the vehicle, can register with the digital platform (i.e. the server system 102) using the input fields provided in the UIs. The owner of the vehicle may provide, as input, personal details such as name, contact information (email address and phone number) and postal address associated with the owner, using the display interface 216. Some examples of the inputs may include, but are not limited to, information associated with the vehicle such as license number, vehicle registration number, type of the vehicle and model of the vehicle, among others. Furthermore, display interface 216, through UIs, facilitates the vehicle owner to provide information corresponding to one or more payments accounts that are to be linked with the vehicle. Such information includes account details related to payment cards issued by one or more financial institutes for carrying out payment transactions by the owner/operator of the vehicle. A registered owner can later log in to the digital platform of the server system 102 by providing his/her credentials, which the owner had provided while registering. The server system 102 stores the details of plurality of vehicles and their respective owners in the database 306.

Service providers such as vehicle parking service provider and toll road service provider may also use their respective communication devices (e.g. mobile phones, laptops, personal computers, etc.) for registering the services offered by the service providers with the digital platform of the server system 102. As an example, a parking lot service provider may be associated with a communication device 402 and a toll road use service provider may be associated with a communication device 404. The communication devices 402 and 404 can access the digital platform for registration of the respective services offered by the corresponding service providers. Upon registering, the server system 102 marks or pins the registered service location on a digital map stored in the database 306 or database 314 discussed earlier in reference with FIG. 3 of the server system 102. The digital platform, while registering, asks the services providers to provide details such as cost for using the services depending upon the type of vehicles, time of the day, days of weeks, etc. The service providers are also asked to provide payment account details for receipt of money from the users of the services, currency, and transaction details, etc., to the server system 104. Once registered, the services providers are provided with login details to use the digital platform (i.e. road/parking service application) hosted by the server system 102. It should be noted that the service providers or vehicle owners make any changes in the registration details, profiles registered with the server system 102 after making a login in the digital platform.

Some example illustrations of the use cases of the services by the vehicles are explained with reference to FIGS. 5A-5B & FIGS. 6A-6B.

Referring now to FIGS. 5A and 5B, scenarios are illustrated where the service location is a parking lot and the service utilized by the vehicle is a parking service in accordance with some embodiments disclosed herein. A service provider (not shown) facilitating the parking service may have bought or rented a parking lot 500 (service location) and is responsible for maintaining the parking lot 500. The service provider may have registered the service location (parking lot 500) with the server system 102.

The digital platform provided by the server system 102 includes an interface 504 that can be shown over the display unit 216 (or display interface) of the vehicle. The interface 504 represents a virtual parking lot 506 to assist the vehicle driver to park the vehicle in appropriate parking slot within the parking lot 500. The interface 504 may be initially defined by the parking lot service provider, or may be created by the server system 102 based on information of the parking lot provided by the parking lot service provider. As shown in FIG. 5A, the digital platform 504 provides/displays virtual parking lot 506 including dotted polygons representative of physical parking slots in the physical parking lot 500. The virtual parking lot 506 is shown in form of bounding polygons, however it can have other shapes as well. The bounding polygons may be mapped with either a geo-fence or a QR code (see, 502 in FIG. 5A) or any other digital or visual target or device capable of capturing and sending the information about the vehicle to the server system 102.

The server system 102 determines if the geo-location of a vehicle such as the vehicle 106 corresponds to the service location (i.e. the parking lot 500). The server system 102 (or in some cases the service provider's communication device 402) may communicate and assist the vehicle with information about an available parking slot relative to the position of the vehicle 106 at the parking lot 500 by browsing the virtual parking lot 506 at the digital platform 504. The server system 102 provisions the virtual parking lot 506 to the IVD 110 thereby facilitating a navigation of route to the available parking slot on the display unit 216. Alternatively or additionally, the communication device 402 of the parking lot service provider can communicate with the IVD 110 through the communication network 116 (or similar networks) to provide assistance to the operator of the vehicle 106 in finding an available parking slot in the parking lot 500.

The server system 102 may eventually log the arrival time and the departure time of the vehicle 106 in the parking lot 500. Alternatively, a system present at the service provider end may also log the arrival time and the departure time of the vehicle 106 and send the logged information to the server system 102. The server system 102 calculates associated fee and communicates the bill indicating the fee to the IVD 110 of the vehicle, and the bill is displayed at the display unit 216.

Another example scenario associated with the parking service is illustrated in FIG. 5B. The service provider may deploy a machine readable code 510 at an entrance and an exit of a parking lot (e.g. parking lot 500). When the vehicle 106 enters the parking lot 500, the server system 102 determines that the vehicle's geo-location corresponds to the parking lot 500. The machine readable code reader 214 of the IVD 110 may scan the machine readable code 510 provided at the entrance of the parking lot (as seen in the FIG. 5B). Upon scanning the machine readable code 510, the IVD 110 provides the location information to the server system 102. The server system 102 may log a time of arrival of the vehicle 106 at the parking lot. Likewise, upon scanning the machine readable code provided at the exit of the parking lot, the server system 102 may log a departure time at which the vehicle left the parking lot. Using the logged data, the server system 102 calculates a parking duration. Subsequently, the fee calculator module 316 of the server system 102 calculates associated fee and communicates the bill indicating the fee to the operator at the IVD 110.

In another example scenario associated with the parking service at a parking lot, a motion detector may be utilized. For instance, when the vehicle's geo-location corresponds to a parking lot and the motion detector 218 of the IVD 110 determines that the vehicle has come to rest, the server system 102 may log a time of parking of the vehicle. Likewise, upon detecting motion of the vehicle after the rest, the motion detector 218, via the SIM module 208, communicates the information to the server system 102. The server system 102 may log the time at which the vehicle started moving out from the parking lot. The time of parking and the time at which the vehicle moved out from the parking lot may be used by the server system 102 to calculate a parking duration. Subsequently, the server system 102 calculates the associated fee and communicates the bill indicating the fee to the operator at the IVD 110.

FIG. 6A illustrates an example representation of a use case associated with a toll road use service, in accordance with an embodiment. Based on the geo-location of the vehicle (e.g. the vehicle 106), the server system 102 identifies that the vehicle 106 is at an entry of a toll road (see, 602). The server system 102 may log the distance travelled by the vehicle 106 (e.g. 1 kilometer, 5 kilometer, etc.) until the vehicle's geo-location corresponds to an exit (not shown) of the toll road 602. Subsequently, the server system 102 calculates associated fee (e.g., $1 per kilometer) and communicates the bill indicating the fee to the operator at the IVD 110.

In another example embodiment, the service provider may also provide machine readable codes (see, 604) at a toll road entry and exit gate (or even on the road dividers or side walls). The machine readable code reader 214 of the IVD 110 scans the machine readable codes 604 provided at the toll road entry gate. Upon receiving information of scan of the machine readable codes 604 provided at the entrance from the IVD 110, the server system 102 initiates a count of the distance travelled by the vehicle 106. Likewise, the service provider may employ machine readable codes at a toll road exit gate (not shown).

FIG. 6B illustrates an example representation of a use case associated with a HOV lane service, in accordance with an embodiment. The HOV lanes (e.g., the HOV lane 652) may typically be next to a divider or side wall (see, 654). The divider or wall 604 can be used to paint QR codes (see, 656) or visual/electronic “targets” can be installed thereon at designated points thereon. The QR codes 656 can be read by the code reader 214 of the IVD 110. Accordingly, the IVD 110 can determine whether the vehicle is traveling in the HOV lane 652 or not. The IVD 110, based on the QR code reading data, can determine a distance (or duration for), over which the vehicle has used the HOV lane service. The server system 102 may also receive information corresponding to the geo-location of the vehicle 106 and the distance travelled by the vehicle 106 from the RADAR module 212a and the LIDAR module 212b of the IVD 110 (based on a reflection from objects 658 on the side wall 654). Thereafter, the server system 102, upon receipt of the usage information from the IVD 110, can calculate the fee, and facilitate payment transaction from the vehicle payment account to the receiver payment account associated with the service provider.

An example representation of an interface 600 of the digital platform is shown in FIG. 6C, where the interface 600 displays a digital map of a toll road to the vehicle user. The interface 600 can be displayed on the display unit 216 or on display of one or more mobile phones present in the vehicle. As shown in the interface 600, is a digital map containing an area 602 that represents the toll road. Also, an information section (see, 604) containing details of the toll road is overlaid in the interface 600. For instance, details of the toll road such as ‘zone no.’, ‘address’, ‘Fee/hour’, ‘Slot left’ are shown in the information section. A license plate (see, 606) of the vehicle is also displayed in the interface 600. If the vehicle operator selects a start button (see, 608), the interface 600 starts navigation for the vehicle to reach the toll road. It should be noted that example representation of FIG. 6C is for example purposes only, and it can be customized in a variety of ways.

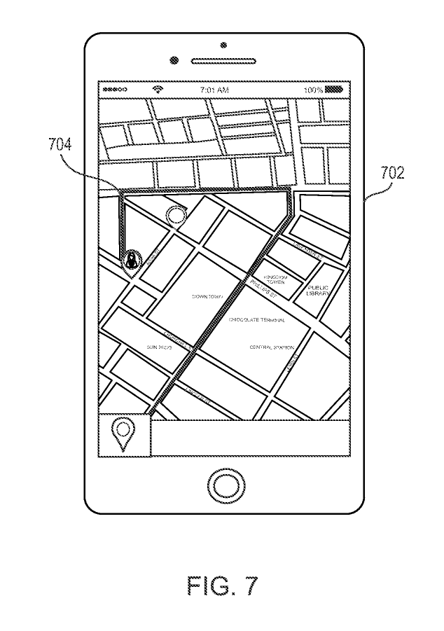

The IVD 110 further includes one or more noise filtering units (not shown) in order to filter noise components from multipath satellite signals to determine precise point positioning of the vehicle in dense canyons and canopies where current GPS technologies face difficulty in providing accurate location estimate. The noise component may exist due to the satellite signals being subjected to multipath effect in urban canyons. The noise filtering units filter out the noise components in the determined geo-location of the vehicle, prior to transmitting the geo-location of the vehicle to the server system 102. FIG. 7 illustrates an interface 702 at the display interface 216 displaying a navigated route (see, 704) where filtering algorithms are applied to correct errors and provide better estimate of the exact location of the vehicle and route.

The server system 102 calculates associated fee for using the service and communicates the bill indicating the fee to the operator at the IVD 110. In an embodiment, the server system 102 may generate one or more bills or a single bill associated with the fees for various services utilized by the vehicle over a predefined period, say 1 month. The one or more bills may be communicated to the IVD 110, and it is displayed at the display interface 216. Once, the bill is displayed at the display unit 206, the digital platform provides an option to the operator to authorize a payment transaction. Herein, authorizing the payment transaction indicates sending a payment authorization information to the server system 102, where the payment authorization information indicates that the amount corresponding to the bill may be deducted from one or more payment accounts linked with either the vehicle, the vehicle owner or any current occupant of the vehicle. The authorization may include validating a biometric of the operator, a PIN, an OTP and a password, among others, that are set while registration with the server system 102. Alternatively, the IVD may be associated with an owner, an occupant or an operator of a vehicle and the vehicle itself by way of registration with the server system. The IVD detect the location and service utilized at the location and autonomously, without requiring an authorization by the user each time, may process the payment transaction from the payment account associated with the operator of the vehicle.

Upon receiving authorization information, the display interface 216 may allow the operator to select a mode of payment. Selection of a mode of payment may redirect the operator to a payment gateway (not shown), where the operator may select payment details, such as payment card type, card number, payment card issuing bank, which subsequently redirects the operator to the financial institute's (e.g., bank's) web page (not shown) to complete the transaction upon authentication of the operator. The financial institute (bank) may be associated with the payment account of the vehicle owner or operator. Alternatively, one of the modes of payment may be a payment wallet (well known in the art). Upon selecting an e-wallet option, the operator may be requested to provide authentication details to deduct funds from the wallet. In some cases, the server system 102 may have a dedicated e-wallet for the making the payments. For instance, the vehicle operator may, while registering, opt for the e-wallet, and can deposit money in the e-wallet, wherein the e-wallet can be used to set off the payment as indicated in the bill generated after usage of the service.

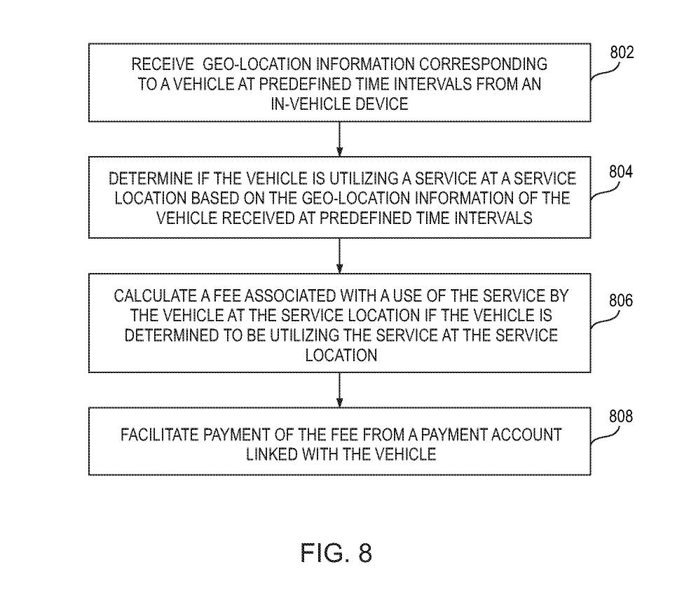

Referring now to FIG. 8, a flowchart 800 illustrates a method 800 for facilitating payment transaction using a geo-location of a vehicle, in accordance with an example embodiment. One or more operations of the method 800 are carried out at the server system 102. The sequence of operations of the method 800 may not be necessarily executed in the same order as they are presented. Further, one or more operations may be grouped together and performed in form of a single step, or one operation may have several sub-steps that may be performed in parallel or in sequential manner.

At operation 802, the server system 102 receives geo-location information corresponding to a vehicle (e.g., the vehicle 106) at predefined intervals. In some cases, the pre-defined intervals may be very low so that the geo-location information can be received on a continuous basis. Accordingly, the geo-location information of the vehicle may be near real time information of the exact position of the vehicle. The geo-location information is received from the IVD 110.

At operation 804, the server system 102 determines if the vehicle is utilizing a service at a service location based on the geo-location information of the vehicle received at predefined time intervals. The server system 102 checks if the geo-location of the vehicle corresponds to a service location, where the service location is at least one of a parking lot, a toll road or a HOV lane. Based on the information, the server system 102 further determines if the vehicle has been parked at the parking lot or if the vehicle has taken the toll road or the HOV lane.

At operation 806 the server system 102 calculates a fee associated with the service if the vehicle is determined to be utilizing the service at the service location. For instance, the server system 102 determines a parking duration and the distance travelled on a toll road (or on the HOV lane) and based on that, a fee associated with one or more of a parking service and a toll road use service (or the HOV lane service) is determined. The server system 102 communicates the bill indicating the fee to the operator at the IVD 110. In another embodiment, the server system 102 may generate one or more bills associated with the fees for various services utilized by a vehicle over a predefined period.

At operation 808 the server system 102 facilitates a payment of the fee from a payment account linked with the vehicle. For facilitating payment transactions, the server system 102 may receive authorization from an owner, an operator or a driver of the vehicle through the display unit 216. The authorization may be validating a biometric of the operator, a PIN, an OTP, a password associated with the operator's account created with the server system 102. Upon providing authorization, the IVD 110 may allow the operator to select a mode of payment.

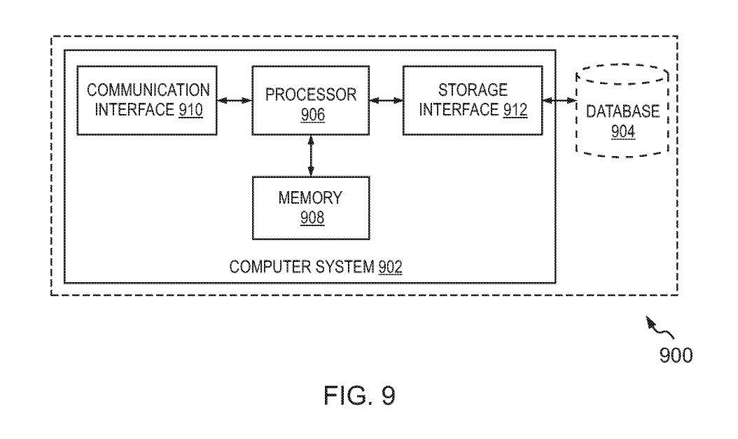

Referring now to FIG. 9 is a simplified block diagram of a server system 900 is illustrated, in accordance with one embodiment of the present disclosure. The server system 900 is an example of a server system 102 that is a part of the environment 100. The server system 900 includes a computer system 902 and a database 904.

The computer system 902 includes a processor 906 for executing instructions. Instructions may be stored in, for example, but not limited to, a memory 908. The processor 906 may include one or more processing units (e.g., in a multi-core configuration).The processor 906 is operatively coupled to a communication interface 908 such that computer system 902 is capable of communicating with a remote device such as the IVD 110 (shown in FIG. 1), financial institutes, external databases, electronic devices of service providers of various services including a parking service and a toll road use service.

The processor 906 may also be operatively coupled to the database 904. The database 904 is any computer-operated hardware suitable for storing and/or retrieving data. The database 904 may include multiple storage units such as hard disks and/or solid-state disks in a redundant array of inexpensive disks (RAID) configuration. The database 904 may include a storage area network (SAN) and/or a network attached storage (NAS) system. In some alternate embodiments, the database 904 may also include magnetic storage devices (such as hard disk drives, floppy disks, magnetic tapes, etc.), optical magnetic storage devices (e.g., magneto-optical disks), semiconductor memories (such as mask ROM, PROM (programmable ROM), EPROM (erasable PROM), Phase-change memory, flash ROM, RAM (random access memory)), etc.

In some embodiments, the database 904 is integrated within the computer system 902. For example, computer system 902 may include one or more hard disk drives as database 904. In other embodiments, database 904 is external to computer system 902 and may be accessed by the computer system 902 using a storage interface 912. The storage interface 912 is any component capable of providing the processor 906 with access to the database 904. The storage interface 912 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 906 with access to the database 904. In some alternate embodiments, the database 904 may also include magnetic storage devices (such as hard disk drives, floppy disks, magnetic tapes, etc.), optical magnetic storage devices (e.g., magneto-optical disks), semiconductor memories (such as mask ROM, PROM (programmable ROM), EPROM (erasable PROM), Phase-change memory, flash ROM, RAM (random access memory)), etc.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 900 and its various components such as the computer system 902 and the database 904 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The server system 900 as illustrated and hereinafter described is merely illustrative of a system that could benefit from embodiments of the invention and, therefore, should not be taken to limit the scope of the invention. It may be noted that the server system 900 may include fewer or more components than those depicted in FIG. 9. As explained above, the server system 900 may be included within or embody an electronic device. Moreover, the server system 900 may be implemented as a centralized system, or, alternatively, the various components of server system 900 may be deployed in a distributed manner while being operatively coupled to each other.

Without in any way limiting the scope, interpretation, or application of the claims appearing below, a technical effect of one or more of the example embodiments disclosed herein is to provide methods and systems for facilitating for facilitating payment transaction using a geo-location of a vehicle. The herein disclosed system provides an IVD operatively communicating with a server system. The IVD transmits precise point position and exact geo-location of a vehicle rather than using an external device such as a smart phone. The present disclosure completely removes the use of smart phones for payment transactions and vehicle positioning. The system requires neither toll gantries nor toll plazas nor meters. Instead, the IVD uses GPS satellite signals to continually determine the vehicle's position, and mobile radio technology to pass the data on to the server system. The server system checks if the vehicle is parked or driving on a tolled road section and if so, calculates and invoices the applicable toll fee on the basis of the pre-defined tariff. This makes the technology especially cost-effective on extensive a complicated tolled road networks because it requires no roadside infrastructure for toll data collection.

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a system described and depicted in FIG. 9. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application \or implementation without departing from the spirit or scope of the claims.

What is claimed is:

1. A computer-implemented method, comprising:
receiving, by a server system, geo-location information corresponding to a vehicle at predefined time intervals, the geo-location information received from an in-vehicle device (IVD) present in the vehicle;
determining, by the server system, if the vehicle is utilizing a service at a service location based on the geo-location information of the vehicle received at predefined time intervals;
if the vehicle is determined to be utilizing the service at the service location, calculating, by the server system, a fee associated with a use of the service by the vehicle at the service location; and
facilitating, by the server system, a payment of the fee based on a payment authorization information received from the IVD, the payment made from at least one payment account linked with the vehicle.

2. The method as claimed in claim 1, wherein the service is a vehicle parking service and the service location is a parking lot comprising a plurality of parking slots.

3. The method as claimed in claim 2, further comprising:
determining, by the server system, if a geo-location of the vehicle corresponds to a geo-location of a parking slot from among the a plurality of parking slots; and
determining, by the server system, a position of the vehicle, arrival time of the vehicle in the parking slot and the departure time of the vehicle from the parking slot, wherein the fee for utilizing the parking slot is determined based on the position, the arrival time, the departure time and a set of parking rules and tariff associated with the parking slot.

4. The method as claimed in claim 1, wherein the service is usage of a toll road, and the service location is the toll road.

5. The method as claimed in claim 4, further comprising:
determining if a geo-location of the vehicle corresponds to geo-location of the toll road; and
determining the fee based, at least in part on, at least one of:
a cost stored in a database for using the toll road, and
a distance travelled by the vehicle on the toll road.

6. The method as claimed in claim 1, wherein the service is usage of a high occupancy vehicle (HOV) lane, and the service location is the HOV lane.

7. The method as claimed in claim 6, further comprising:
determining if a geo-location of the vehicle corresponds to geo-location of the HOV lane; and
determining a distance travelled by the vehicle on the HOV lane, wherein the fee for utilizing the HOV road is determined based, at least in part, on the distance travelled.

8. The method as claimed in claim 1, further comprising:
generating, by the server system, a digital map overlaid with information related to parking slots in one or more parking lots, toll roads and HOV lanes; and
wherein determining if the vehicle is utilizing the service at the service location comprises monitoring position of the vehicle on the digital map, by the server system, based on the geo-location information.

9. The method as claimed in claim 1, further comprising:
facilitating, by the server system, registration with a digital platform provisioned by the server system of at least one of:
the vehicle; and
the service offered by a service provider at the service location.

10. The method as claimed in claim 1, further comprising:
provisioning, by the server system, a digital platform to the service provider to create a virtual parking zone for each parking slot in a parking lot, wherein each virtual parking zone is associated with at least one:
a geo-fence associated with respective set of parking rules and tariff, and
a QR code, and
wherein each of the geo-fence and the QR code is configured to facilitate tracking of the usage of the respective parking slot.

11. The method as claimed in claim 1, further comprising:
provisioning, by the server system, a digital platform to the service provider to provide substantially accurate mapping of at least one of toll roads, driving lanes, lane usage rules and fees based on location, time of day and relative congestion.

12. The method as claimed in claim 1, wherein the geo-location information is based on one or more of satellite signals, image capture of location identifying QR codes or bar codes, radar based location detection and light detecting and ranging (LIDAR) based location detection.

13. The method as claimed in claim 1, the geo-location information is determined based on filtering out noise components from the one or more of satellite signals, by the IVD, wherein the noise components correspond to multipath effect in the one or more satellite signals in urban canyons.

14. The method as claimed in claim 1, further comprising:
generating, by the server system, a bill comprising the fee calculated for utilizing the service by the vehicle at the vehicle location;
provisioning, by the server system, the bill to an operator of the vehicle, the bill provisioned to the operator of the vehicle within a display interface included in the vehicle;
receiving, by the server system, the payment authorization information from the operator of the vehicle, the payment authorization information provided by the user using the display interface;
determining, by the server system, if the operator of the vehicle is authorized to pay the fee based on the payment authorization information; and
if the operator of the vehicle is authorized, deducting, by the server system, the fee indicated in the bill from the at least one payment account.

15. A server system, comprising:
a communication interface for receiving geo-location information corresponding to a vehicle at predefined time intervals, the geo-location information received from an in-vehicle device (IVD) present in the vehicle; and
a processor, upon receipt of the geo-location information, configured to cause the server system to at least:
determine if the vehicle is utilizing a service at a service location based on the geo-location information of the vehicle received at predefined time intervals;
if the vehicle is determined to be utilizing the service at the service location, calculate a fee associated with a use of the service by the vehicle at the service location; and
facilitate a payment of the fee based on a payment authentication received from the IVD, the payment made from at least one payment account linked with the vehicle.

16. The server system as claimed in claim 15, further comprising a database configured to store details of the vehicle, details of at least one payment account, details of the service location, and details of payment accounts associated with a service provider entity providing the service.

17. The server system as claimed in claim 15, wherein the service comprises at least one of a parking service, usage of a toll road, and usage of a high occupancy vehicle (HOV) lane.

18. The server system as claimed in claim 15, wherein the server system is further caused to:
generate a digital map overlaid with information related to parking slots in one or more parking lots, toll roads and HOV lanes; and
wherein the server system is caused to monitor position of the vehicle on the digital map based on the geo-location information to determine if the vehicle is utilizing the service at the service location.

19. The server system as claimed in claim 18, wherein the server system is further caused to provision a digital platform for performing a registration of the vehicle and a registration of the service with the digital platform.

20. The server system as claimed in claim 18, wherein the server system is further caused to:
generate a bill comprising the fee calculated for utilizing the service by the vehicle at the vehicle location;
provision the bill to an operator of the vehicle, the bill provisioned to the operator of the vehicle within a display interface included in the vehicle;
receive the payment authorization information from the operator of the vehicle, the payment authorization information provided by the user using the display interface;
determine if the operator of the vehicle is authorized to pay the fee based on the payment authorization information; and
if the operator of the vehicle is authorized, deduct the fee indicated in the bill from the at least one payment account.

21. A method, comprising:
collecting, by an in-vehicle device (IVD) present in the vehicle, geo-location information corresponding to the vehicle;
transmitting the geo-location information to a server system at predefined time intervals;
if the vehicle is utilizing a service at a service location, receiving a fee associated with usage of the service from the server system, wherein the server system determines whether the vehicle is utilizing the service if a geo-location of the vehicle determined from the geo-location information corresponds to the service location; and
providing a payment authorization information to the server system to make a payment of the fee from at least one payment account linked with the vehicle.

22. The method as claimed in claim 21, wherein collecting the geo-location information comprises receiving satellite signals from a satellite signal receiver.

23. The method as claimed in claim 22, wherein collecting the geo-location information comprises filtering out noise components from the satellite signals, by the IVD, wherein the noise components correspond to multipath effect in the satellite signals in urban canyons.

24. The method as claimed in claim 21, further comprising providing image data in surrounding of the vehicle as part of the geo-location information to the server system, the image data received from a camera linked with the IVD.

25. The method as claimed in claim 21, further comprising providing location data in surrounding of the vehicle as part of the geo-location information to the server system, the location data obtained from a RADAR module linked with the IVD.

26. The method as claimed in claim 21, further comprising providing location data in surrounding of the vehicle as part of the geo-location information to the server system, the location data obtained from a light detecting and ranging (LIDAR) module linked with the IVD.

27. The method as claimed in claim 21, further comprising providing a machine readable code reading data as part of the geo-location information to the server system, the machine readable code reading data obtained from a machine readable code reader associated with the IVD.
